(19) United States
(12) Patent Application Publication
(10) Pub. No.: US 2015/0195432 A1
(43) Pub. Date: Jul. 9, 2015

(54) Modular Camera Core

(71) Applicant: Lyve Minds, Inc., Cupertino, CA (US)

(72) Inventors: Mihnea Calin Pacurariu, Los Gatos, CA (US); David Hoenig, Los Gatos, CA (US); Andreas von Sneidern, San Jose, CA (US); Joseph Palmer, Cupertino, CA (US)

(21) Appl. No.: 14/147,396

(22) Filed: Jan. 3, 2014

(51) Int. Cl. H04N 5/225; H04N 1/00; H04N 5/232

(52) U.S. Cl. CPC H04N 5/2252; H04N 5/23222; H04N 1/00204; H04N 1/00538; H04N 5/23203; H04N 2101/00

(57) ABSTRACT

A modular camera comprising a camera capable of capturing digital video, audio, and photograph data, a processor capable of controlling the controller to initiate the capture of digital video, audio, or photograph data and receive the captured digital video, audio, or photograph data and transferring the captured digital video, audio, and photograph data to an external computing device, a memory for storing captured digital video, audio, or photograph data, an electrical connection connected to the processor, and a housing which houses the camera, processor, and the electrical connection, wherein the housing is configured to couple with a plurality of external camera modules, each of which encloses at least a portion of the housing and which includes a housing electrical connection which connects electrically to the electrical connection of the modular camera.

### CROSS-REFERENCE TO RELATED APPLICATIONS

This application is related to U.S. patent application Ser. No. ______, filed Jan. 3, 2014, titled “Modular Camera Core and Modular Camera Expansion System,” U.S. patent application Ser. No. 14/135,568, filed Dec. 19, 2013, titled “Image Orientation Adjustment Based on Camera Orientation,” both of which are incorporated herein by reference in their entireties.

### BACKGROUND OF THE INVENTION

1. The Field of the Invention

The present invention relates generally to a modular digital camera with a camera core which is configured to be used in a plurality of different camera configurations.

2. The Relevant Technology

As people become more and more interested in capturing digital photographs and digital videos, the proliferation of digital cameras has become more common. Cellular phones have evolved so as to include cameras which are capable of capturing digital video and digital photographs. Although these cameras provide various benefits because they are integrated with a device that many users already carry on a regular basis, there are various advantages to having a separate camera, including the ability to have a camera with higher quality components, improved controls, longer battery life, and which do not carry the security concerns that come with a cellular phone which also stores personal information.

Typically, the stand-alone digital cameras currently available in the market include simple “point and shoot” cameras which include a wholly integrated device which offer no modularity and which consequently require a user to select a single camera which will be suitable for a variety of situations, including which lens, features, and the like will be most easily adapted to a variety of situations. Generally, this forces consumers to find the best “overall” digital camera, where the consumer sacrifices features and components that would be advantageous in some situations for the benefits of features and components that would be more commonly used. Other digital cameras include those which allow a user to remove specific components of the camera, including a flash, filter, or lens. Generally, these cameras are more expensive and bulky.

Digital cameras include a series of functional components such as lenses, optical filters, one or more electronic image sensor arrays, electronic circuits to capture, process, and store images from the image sensor array, internal or external memory devices to store and transfer image files, power supplies, and a display system to preview the captured images. These components are typically integrated and interdependent from each of an optical, electronics, and physical perspective. As described above, in some instances, external lenses and power supplies may be attached to and removed from the camera, but the remaining components are typically permanently integrated into a main framework or housing without any practical ability to be removed and replaced. As a consequence, due to the limited configurability associated with conventional cameras, they are typically suitable for a limited range of applications and contexts. As a result, users who want to shoot in a variety of contexts and for a variety of applications often need to purchase multiple cameras to achieve desired results.

Thus, notwithstanding the various digital camera options available in the art, there remains a need for a camera system that is fully customizable by the user, and which overcomes the limitations discussed above.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to a modular camera which is capable of capturing digital video and photograph data.

A first aspect of the invention is a modular camera including a camera capable of capturing digital video, audio, and photograph data, a processor capable of controlling the controller to initiate the capture of digital video, audio, or photographic data and receive the captured digital video and photograph data and transferring the captured digital video, audio, or photograph data to an external computing device, a memory connected to the processor for storing the captured digital video, audio, or photograph data, an electrical connection connected to the processor, and a housing which houses the camera, processor, and the electrical connection, wherein the housing is configured to couple with a plurality of external camera modules, each of which encloses at least a portion of the housing and which includes a housing electrical connection which connects electrically to an electrical connection of the modular camera.

A second aspect of the invention is a modular camera system including a modular camera core which includes a camera capable of capturing digital video, audio, and photograph data, a processor capable of controlling the controller to initiate the capture of digital video, audio, or photograph data and receive the captured digital video, audio, or photograph data, and transferring the captured digital video, audio, and photograph data to an external computing device, a memory connected to the processor for storing captured digital video, audio, and photograph data, an electrical connection connected to the processor, and a housing which houses the camera, processor, and the electrical connection. The modular camera system also includes a plurality of external camera modules each of which is configured to couple with the modular camera core, each of which encloses at least a portion of the housing and which includes a housing electrical connection which connects electrically to an electrical connection of the modular camera core.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a modular camera system and a modular camera core according to an embodiment of the invention;

FIGS. 2A-2B illustrate an example of various components of the modular camera core according to embodiments of the claimed invention described herein;

FIG. 3 is a block diagram illustrating various electrical components of the modular camera core and a corresponding camera expansion module according to embodiments described herein;

FIGS. 4A-4B illustrate an example of various components of a camera expansion module according to embodiments described herein;

FIG. 5 illustrates the assembly of the modular camera assembly according to an embodiment described herein;

FIG. 6 illustrates an assembled modular camera assembly according to an embodiment described herein; and

FIG. 7 shows an illustrative computational system for performing functionality to facilitate implementation of embodiments described herein.

### DETAILED DESCRIPTION OF THE PREFERRED EMBODIMENTS

The present invention relates generally to a modular digital camera with a camera core which is configured to be used in a plurality of different camera configurations.

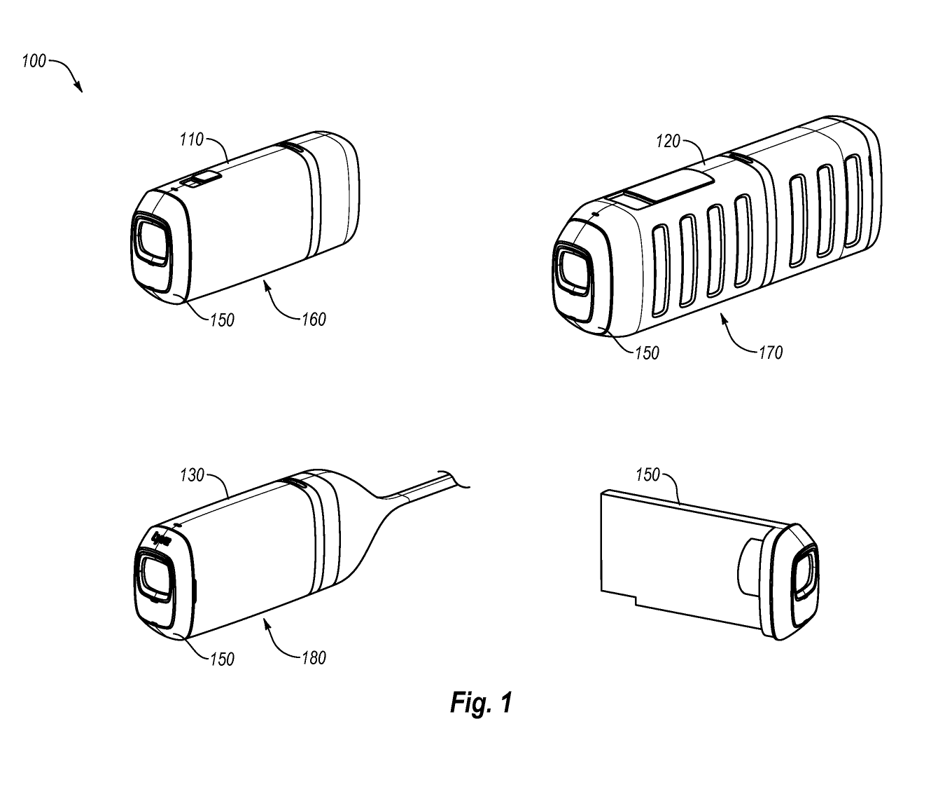

As is shown in FIG. 1 of the drawings, embodiments described herein are directed to a modular digital camera system 100 which includes a modular camera core 150, which is configured to be coupled with a plurality of different other modular camera products so as to provide a user with a simple camera system which is capable of being specifically modified for a variety of uses.

In the example shown in FIG. 1, the modular digital camera system 100 includes the modular camera core 150, which as described more fully below, is capable of being coupled to a variety of different camera products. In this example, the modular camera core 150 is configured to couple with a pocket camera expansion module 110 which includes an assortment of features and controls which are designed to be useful in a variety of situations. When coupled with the pocket camera expansion module 110, the modular camera core 150 and pocket camera expansion module 110 together form a pocket camera 160 which is designed to be a general purpose camera which may be carried by a user on a regular basis and which may be used in a variety of situations which a user may encounter on a regular basis. The modular camera core 150 is also configured to couple with an active camera expansion module 120 which includes features and controls which are designed to be useful in an athletic or more active setting, such as while engaging in a sport or other recreational activity. When coupled with the active camera expansion module 120, the modular camera core 150 and active camera expansion module 120 together form an active camera 170 which is specifically designed to have the various features that would be useful when capturing photograph, video, or audio data when engaging in a recreational activity. Additionally, the modular camera core 150 is also configured to couple with a cable camera expansion module 130 so as to form a cable camera configuration 180 which is designed to connect to a computer or other electronic device capable of communicating with the modular camera core 150 via a cable.

As will be illustrated more fully below, each of the various camera expansion modules 110, 120, and 130 each have differing features and aspects, and one advantage of the embodiments described herein is the ability for a user to select the camera expansion module 110, 120, or 130 which best serves the immediate needs of the user. For example, when assembled, the pocket camera 160 may be lighter than the active camera 170, which may be advantageous for everyday use or in situations where simplicity and portability are desired. In contrast, when assembled, the active camera 170 has, for example, a larger battery life, a noise-cancelling microphone, and the ability to be coupled to a variety of mounts, including a dash mount, a bike mount, and/or a suction mount. Hence, while it may be larger and heavier, the active camera 170 has additional features which are not available in the pocket camera 160. Further, the cable camera configuration 180 is specifically designed to connect the modular camera core 150 to a computer or other electronic device so as to enable the transfer of pictures, audio data, and/or video data, perform updates to the software operating on the modular camera core 150, or the like. Because the designated purpose of the cable camera configuration 180 is to facilitate the transfer of data to and from the modular camera core 150, the cable camera configuration 180 may have limited camera functionality. Conversely, because there is the designated cable camera expansion module 130, there is no need to provide a connection port in either the pocket camera 160 or the active camera 170. As may be understood, this provides an advantage since it allows the pocket camera 160 and the active camera 170 to have a simpler design.

Although the embodiments described herein describe a limited number of camera expansion modules 110, 120, and 130, it should be understood that the examples described herein are meant to be illustrative only and that other camera expansion modules could be used in association with the modular camera core 150 described herein. As such, the examples described herein are not intended to be limiting of the claimed invention.

For example, the modular camera core 150 may also be used in association with camera expansion modules which are created by third parties or in configurations where a third party product is adapted so as to become a camera expansion module itself For example, a vehicle could be adapted to house and act as a camera expansion module for one or more modular camera core 150. Similarly, a helmet could also be adapted to be a camera expansion module which houses the modular camera core 150 and also contain various components such as those described herein with respect to the camera expansion modules 110 and 120.

### A. Modular Camera Core

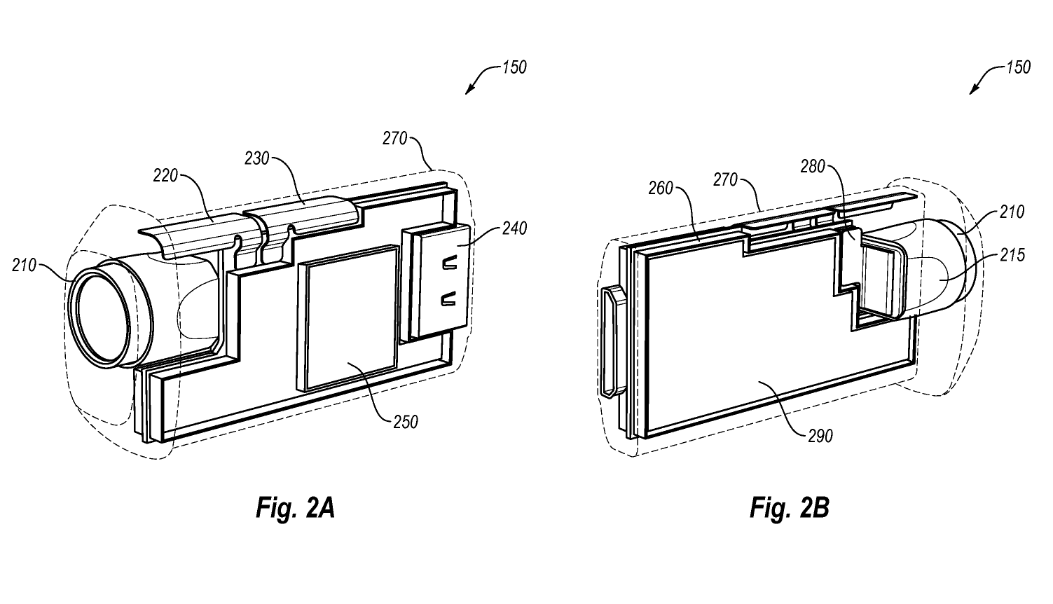

FIGS. 2A-2B illustrate an example of the modular camera core 150 that may be used in association with the embodiments described herein. As is shown in the front view shown in FIG. 2A, the modular camera core 150 includes, for example, a camera lens 210 which may be used in capturing digital video and digital photograph and a lens holder 215 which holds the camera lens 210 in place (shown in FIG. 2B). The modular camera core 150 may also include a GPS antenna 220 which may be used in association with a space-based satellite navigation system that provides location and time information when the GPS antenna 220 communicates with one or more GPS satellites.

The modular camera core 150 also includes a Bluetooth and Wi-Fi antenna 230 which, as may be described more fully below, may be used to communicate with various other devices, including an external computing device, controls on the various camera expansion modules 110, 120, and 130, and the like. The modular camera core 150 also includes a connection 240, which may be used to provide a physical connection with components of the various camera expansion modules 110, 120, and 130.

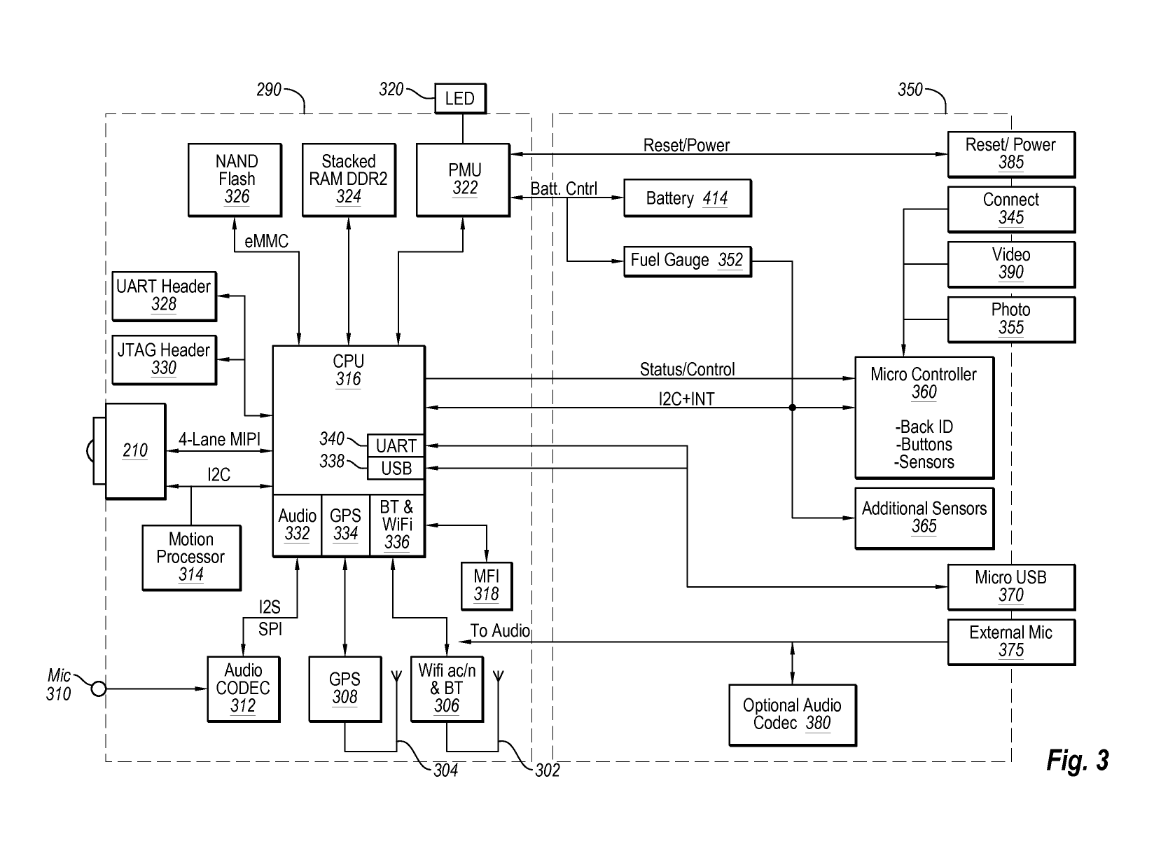

As is shown in FIG. 2B, the modular camera core 150 also includes a printed circuit board assembly (PCBA) 290 which mechanically supports and electrically connects electronic components using conductive tracks, pads, and other features etched from copper sheets laminated onto a non-conductive substrate. Examples of components which may comprise a portion of the PCBA 290 are described in more detail with respect to FIG. 3. In addition to the PCBA 290, the modular camera core 150 may also include a heat spreader 250, a PCBA shielding 260, and a camera flex connection 280 which electrically connects the camera lens 210 to the PCBA 290.

A casing 270 houses the various components of the modular camera core 150 and may be formed of a material or a combination of materials so as to provide stability and security for the various components housed therein. The materials used for the casing may include a combination of plastics, metals, or other materials currently known in the art.

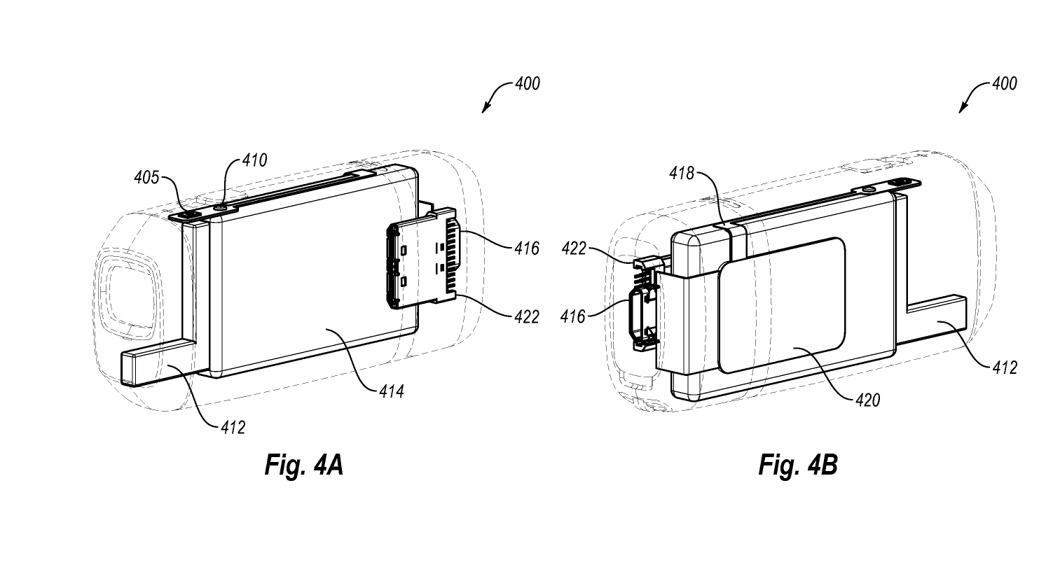

FIG. 3 is a block diagram which illustrates an example of the various electrical components of the modular camera core 150 which may be integrated into or used in association with the PCBA 290. FIG. 3 also illustrates an example of the various electrical components of the camera expansion module 110, 120, or 130, which may be integrated into or used in association with the PCBA 290 of the camera expansion module, which is also illustrated in FIGS. 4A-4B and described more fully below.

The PCBA 290 includes a CPU 316 or other microprocessor or microcomputer that carries out the instructions of a computer program by performing the basic arithmetical, logical, and input/output operations of the system. As is shown in FIG. 3, the CPU 316 is connected to a variety of different components and controls the various components. In this example, the CPU 316 receives data from the camera lens 210 via a 4-lane MIPI or other form of interface and may also be connected to a motion processor 314 which may perform sub-processing routines, including powering components, such as an accelerometer, compass, and/or gyroscope and performing processing based on the data collected from those components to provide 9-axis motion processing. Further, the CPU 316 may include a camera module, not shown, which is specifically designed to control the exchange of data between the CPU 316 and the camera lens 210.

The PCBA 290 is also connected to a microphone 310 via an audio CODEC 312 which may be used to configure digital audio data captured by the microphone 310 according to a given audio file format or streaming media audio format. This digital audio data is then sent to an audio module 3332 of the CPU 316 for compressing and decompressing, as necessary. As briefly described with respect to FIGS. 2A-2B, the CPU 316 is also connected to a GPS antenna 304 via a GPS module 308, which may be used to perform telemetry or other location or positioning processing. The GPS data may then be sent to a GPS module 334 of the CPU 316. The CPU 316 is also connected to a Wi-Fi and/or Bluetooth antenna 302 via a Wi-Fi and Bluetooth module 306. The CPU 316 may also include a MFi module 318 so as to enable the CPU 316 and the modular camera core module 150 to connect with Apple® brand products. The data from the MFi module 318 and the Bluetooth and Wi-Fi data from the Wi-Fi and Bluetooth module 306 may be sent to a Bluetooth and Wi-Fi module 336 of the CPU 316 for further processing and, in some instances as described more fully below, to initiate control operations.

As may be understood by one of skill in the art, by performing a subset of the processing at the modules 314, 312, and 306, and 308, the amount of processing performed by the CPU 316 is reduced, resulting in increased battery life of the system. In other configurations, the processing may be performed by modules within the CPU 316.

The CPU 316 may also include a Universal Serial Bus (USB) port 338 for connecting to an external device and/or the PCBA of the camera expansion module 350 and a Universal Asynchronous Receiver/Transmitter (UART) 340 which translates data between parallel and serial forms. Other embodiments may also include dual USB ports and/or a multiplexer (not shown).

The modular camera core 150 may also include an LED light 320 which is controlled by a Power Management Unit (PMU) 322. The PMU 322 may be powered by a battery 414 stored in the camera expansion module. The modular camera core 150 may also include various types of memory, including ROM, RAM 324, and flash memory 326 which may be used to store various types of data including stored video and picture captured by the system. Further, the modular camera core may include other components such as a JTAG header 330 for testing the PCBA 290 and a UART header 328.

In the embodiments described herein, the modular camera core 150 includes various features including the camera lens 210 which is capable of capturing digital video, audio, and photograph data. The digital video may be captured in a variety of resolutions, including 1080p60, 720p120, 480p240 format, and in 8-13MP stills, although it should be understood that a variety of resolutions may be used in association with the embodiments described herein.

In one embodiment, the camera lens 210 includes a fixed focus lens although the embodiments described herein may be adapted to include variable focus lens and other optical components. The camera lens 210 may also include a temporary flash which may be powered by the battery 414 of the corresponding camera expansion module 110 or 120.

### B. Controlling the Modular Camera Core

As will be described more fully below, the modular camera core 150 is designed without a separate power supply and without an integrated user interface. Rather, these elements are designed to be incorporated in the camera expansion module 110, 120, or 130, and the modular camera core 150 is designed to be controlled remotely by an external computing device which is capable of communicating with the modular camera core 150 via the Bluetooth or Wi-Fi connection. In some instances, the Bluetooth connection may be used to control the features of the modular camera core 150 while the Wi-Fi connection is used to transfer data between the memory of the modular camera core 150 and the external device.

As may be understood, one advantage of enabling external control is that the camera, such as when incorporated into the pocket camera 160 or the active camera 170, may be mounted by a user who then can use his or her cellular phone or other device capable of communicating with the modular camera core 150 of the pocket camera 160 or the active camera 170 to control the device. In some instances, this may include using the external device as a viewfinder, which is capable of receiving streaming data from the modular camera core 150 to determine what the camera is currently viewing. As may be understood, such a configuration would enable a photographer to use an external device to compose, and in many cases to focus, the picture. This is particularly advantageous in instances where the photographer desires to be in the picture itself or in instances where the camera is going to be used in a sports setting where the photographer does not want to risk the possibility of a viewfinder being damaged or the additional bulk and controls necessary to operate the camera, but where the photographer still wants to exert control over the picture or video being captured. Additionally, the remote control would also be advantageous in situations where the photographer wishes to be positioned separate from the camera because he or she is unable to fit in the space where the camera is positioned or in other instances where the safety of the photographer requires the photographer to be located remotely from the camera.

Further, the external control may also be used to delete data stored in the memory of the modular camera core 150 or to transfer data from the memory from the modular camera core 150 or between different types of memory within the modular camera core 150 or the camera expansion module 110 or 120. The external control may also add metadata to video or photograph data including adding metadata corresponding to information collected from other components of the modular camera core 150 including GPS information from the GPS module 308.

In some instances, this may include transferring the video or photograph data to a storage network, such as the storage network described in copending patent application Ser. No. 14/137,654 entitled “Storage Network Data Allocation,” filed Dec. 20, 2013, which is herein incorporated by reference in its entirety.

In another configuration, the external control may be used to perform basic camera functions, such as setting flash settings, initiating the capture of a photo, and the starting or stopping of a video recording. In addition or in the alternative, some of these features may be initiated using a button on the corresponding camera expansion module 110 or 120. Further, the external control may also be used to mark video highlights. Additionally, embodiments described herein may also perform pass-through control of external devices, such as motor heads, lights, etc., which are connected to or in communication with the modular camera 160 or 170.

In addition to controlling operations of the modular camera core 150, the camera expansion modules 110, 120, and 130 may also be controlled remotely via the Bluetooth or Wi-Fi connection.

### C. The Camera Expansion Modules

FIGS. 4A and 4B are exemplary figures which illustrate the components of the camera expansion module 110 or 120. As is described more fully below, one distinction between the pocket camera expansion module 110 and the active camera expansion module 120 is the size and capacity of the battery included in the respective camera expansion modules 110 and 120, and many components of the two camera expansion modules 110 and 120 are similar. As such, the camera expansion module shown in FIG. 3 and FIGS. 4A-4B is shown as a generic camera expansion module 400 which includes exemplary components which may be included or excluded from the different camera expansion modules 110, 120, or 130, depending on the specific design of the individual pocket camera expansion module 110.

The generic camera expansion module 400 of FIGS. 4A-4B includes a video record slider switch 410 which may be used to initiate the capture of a digital video data. As is shown in FIG. 4B, the video record slider switch 410 is connected to a video record slider switch flex 418, which is in turn connected to the camera expansion module PCBA 420 which operates to control the camera lens 210 and the motion processor 314 to initiate the capture of data. In an alternative embodiment, the video record slider switch flex 418 may be eliminated.

In some instances, sliding the video record slider switch 410 may initiate the capture of the digital video data and a second sliding operation of the video record slider switch 410 may terminate the video capture. In another configuration, the video record slider switch 410 may be configured to capture the digital video for the duration of the period at which the slider switch is held. As is shown in FIG. 1, the video record slider switch 410 may also be made out of different materials, depending on the configuration of the camera expansion module. For example, in the pocket camera expansion module 110, the video record slider switch 410 may be made from a polished metal material to provide a sleek overall look whereas in the active camera expansion module 120, the video record slider switch 410 is made from a durable plastic material that is specifically designed to be used when an operator is wearing gloves or other materials typically worn during a recreational activity.

The generic camera expansion module 400 of FIGS. 4A-4B also includes a photo capture button 405 which may be used to initiate the capture of a digital photograph. The generic camera expansion module 400 may also include the battery 414 and a battery protection circuitry 412.

In one embodiment, the battery 414 of the active camera expansion module 120 is designed to have greater battery life than the battery 414 of the pocket camera expansion module 110. For example, the battery of the pocket camera expansion module 110 may be 45-60 minutes whereas the battery life of the battery 414 of the active camera expansion module 120 may be two or more hours. Furthermore, the battery 414 of the active camera expansion module 120 may be designed to be replaceable.

The generic camera expansion module 400 of FIGS. 4A-4B also includes a pin connection 422 for connecting to the corresponding pin connection of the modular camera core 150. In one embodiment, the pin connection 422 is a proprietary 30-pin connection, although it should be understood that a plurality of different connection methods may be used without departing from the scope and meaning of the claimed invention.

The generic camera expansion module 400 of FIGS. 4A-4B also includes a micro-USB port 416 so as to enable the transfer of data to an external device.

FIG. 3 illustrates the various electrical components of the generic camera expansion module 400. In the example shown in FIG. 3, many elements shown may be selectively included in the various camera expansion modules 110, 120, and 130 and are shown in boxes with dotted lines. For example, an external noise-cancelling microphone 375 and an accompanying audio CODEC 380 may be included in the active camera expansion module 120, but excluded from the pocket camera expansion module 110 and the cable camera expansion module 130. Similarly, the micro USB port 370 may be included in the pocket camera expansion module 110 and the active camera expansion module 120, but excluded from the cable camera expansion module 130, since the cable camera expansion module 130 may be configured to integrate the micro USB port or utilize an additional type of cable for data transfer.

Additionally, as described above, while the pocket camera expansion module 110 and the active camera expansion module 120 include the battery 414, the cable camera expansion module 130 may not include the battery 414 or an accompanying fuel gauge 355 which is used to determine how much battery life remains in the battery 414.

The PCBA 290 of the generic camera expansion module 400 includes a microcontroller 360 for controlling the various buttons and sensors of the generic camera expansion module. Further, the PCBA 290 may also include additional sensors 365, including a detector for detecting the external noise of the area so as to initiate the noise-cancelling features of the external noise-cancelling microphone 375. As is described above, the generic camera expansion module 400 may be connected to the video record slider switch 410 and the photo capture button 405 and may include a video sensor 390 for detecting the sliding of the video record slider switch 410, and a photo sensor 355 for detecting the pushing of the photo capture button 405. A connection button (not shown) may also be included on the cable camera expansion module 130 and a connect sensor 345 may be included to detect that the connection button has been pressed.

Additionally, any of the buttons or sliders on the various camera expansion modules 110, 120, and 130 may be also used to reset or power on or off the pocket camera 160, active camera 170, or cable camera configuration 180. For example, holding down the photo capture button 405 or a connection button for a predetermined period of time or some combination of pressing the photo capture button 405 and sliding the video record slider switch 410 may be used to imitate such an operation and a reset/power detector 385 may be used to detect such an operation.

In addition to these electrical components, other physical features may be included in the various camera expansion modules 110, 120, and/or 130, depending on their intended use. For example, the camera expansion modules 110, 120, and/or 130 may include connections for attaching the camera expansion modules 110 and 120 to a lanyard, clip, or a key holder, or as described above to a variety of different mounts. Using this combination of specialized mechanical and electrical components, the various camera expansion modules 110, 120, and 130 can be specially designed for a variety of camera applications.

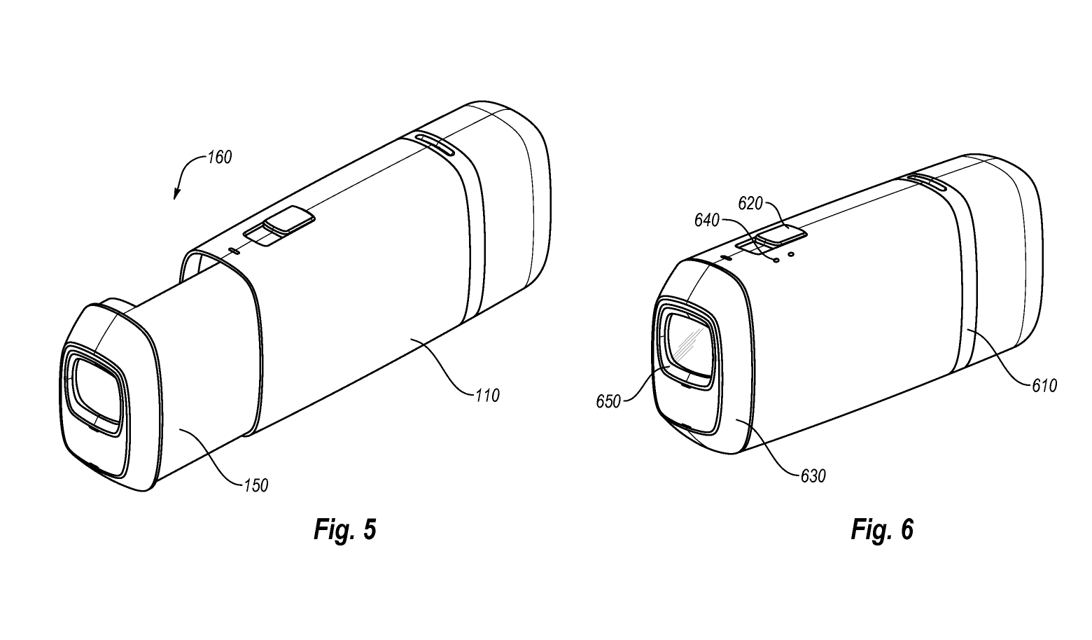

FIG. 5 illustrates the process wherein the modular camera core 150 is coupled to the pocket camera expansion module 110 to form the assembled pocket camera 160. As is shown in FIG. 5, the modular camera core 150 slides into a housing of the pocket camera expansion module 110 and the two components are joined mechanically and electrically by their respective pin connections 240 and 422. In some instances, the pocket camera expansion module 110 may include a button or other mechanism for initiating the release of the modular camera core 150 from the pocket camera expansion module 110.

FIG. 6 illustrates the various aspects of the assembled pocket camera 160 according to one embodiment. The assembled pocket camera 160 includes the video record slide button and a photo capture button 620 which are integrated in this embodiment. A tapered front of the assembled pocket includes a metal bezel 630 and a metal band 610 is formed at a rear of the assembled pocket camera 160. LED indicators 640 on the top of the assembly indicate that the camera is powered on and/or that a recording is in progress or that a data transfer is in process. A crystal cover 650 is placed over the front of the camera lens 210 so as to provide clear pictures and video while providing durability. In one embodiment, the modular camera core 150 any of the camera expansion modules 110, 120, and 130 are each designed to be waterproof or water resistant.

By providing the various modular components described herein, the modular camera system described herein provides a camera which may be easily adapted for a variety of different purposes. For example, specific camera expansion modules 110 and 120 may be selected which provide differing user interfaces, physical attributes, electrical components, and battery life that are better suited for a variety of situations. Further, the additional cable camera expansion module 130 may be used that is specifically designed for data transfer.

In some instances, a user may purchase a variety of different camera expansion modules 110, 120, and 130 with the modular camera core 150. In one embodiment, the modular camera core 150 may be sold together with the three separate camera expansion modules 110, 120, and 130. In another embodiment, the modular camera core 150 may be sold with only one camera expansion module 110, 120, or 130, with the other camera expansion modules being sold separately. As may be understood, by enabling this modularity, the system described herein offers a degree of personalization and adaptability which is not currently known in the art.

Further, by providing the central modular camera core 150, embodiments described herein allow for further camera expansion modules to be developed and offered for sale which include new features or components, which would enable a user to upgrade or further personalize his or her modular camera without having to purchase an entirely new camera system. By providing the level of modularity and customization described herein, the embodiments described herein provide advantages not currently known in the art.

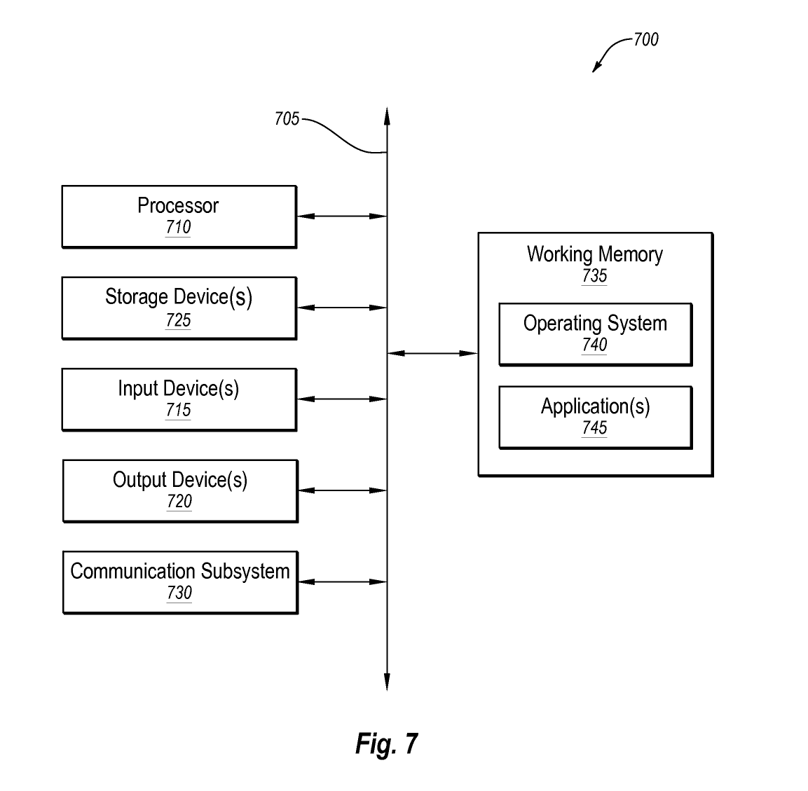

A computational system 700 (or processing unit) illustrated in FIG. 7 can be used to perform any of the embodiments of the invention. For example, the computational system 700 can be used alone or in conjunction with other components to execute all or parts of the processes described above. As another example, the computational system 700 can be used to perform any calculation, solve any equation, perform any identification, and/or make any determination described here. The computational system 700 includes hardware elements that can be electrically coupled via a bus 705 (or may otherwise be in communication, as appropriate). The hardware elements can include one or more processors 710, including, without limitation, one or more general purpose processors and/or one or more special purpose processors (such as digital signal processing chips, graphics acceleration chips, and/or the like); one or more input devices 715, which can include, without limitation, a mouse, a keyboard, and/or the like; and one or more output devices 720, which can include, without limitation, a display device, a printer, and/or the like.

The computational system 700 may further include (and/or be in communication with) one or more storage devices 725, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 700 might also include a communications subsystem 730, which can include, without limitation, a modem, a network card (wireless or wired), an infrared communication device, a wireless communication device, and/or chipset (such as a Bluetooth device, an 802.6 device, a Wi-Fi device, a WiMax device, cellular communication facilities, etc.), and/or the like. The communications subsystem 730 may permit data to be exchanged with a network (such as the network described below, to name one example) and/or any other devices described herein. In many embodiments, the computational system 700 will further include a working memory 735, which can include a RAM or ROM device, as described above.

The computational system 700 also can include software elements, shown as being currently located within the working memory 735, including an operating system 740 and/or other code, such as one or more application programs 745, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 725 described above.

In some cases, the storage medium might be incorporated within the computational system 700 or in communication with the computational system 700. In other embodiments, the storage medium might be separate from the computational system 700 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 700 and/or might take the form of source and/or installable code, which, upon compilation and/or installation on the computational system 700 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it would be understood that the various changes, substitutions, and alterations could be made hereto without departing from the spirit and scope of the invention.

What is claimed is:

1. A modular camera comprising:
a camera capable of capturing digital video, audio, and photograph data;
a processor capable of controlling the controller to initiate the capture of digital video, audio, or photographic data and receive the captured digital video, audio, or photograph data and transferring the captured digital video, audio, or photograph data to an external computing device;
a memory connected to the processor for storing captured digital video, audio, or photograph data;
an electrical connection connected to the processor; and
a housing which houses the camera, processor, and the electrical connection,
wherein the housing is configured to couple with a plurality of external camera modules, each of which encloses at least a portion of the housing and which includes a housing electrical connection which connects electrically to an electrical connection of the modular camera.

2. The modular camera of claim 1, the modular camera further comprising a means for communicating with an external computing device.

3. The modular camera of claim 2, wherein the means for communicating with an external computing device comprises a wireless communication system.

4. The modular camera of claim 3, wherein the wireless communication system enables the external computing device to communicate with the processor to control the processor and remotely initiate the capture of digital video and photograph data.

5. The modular camera of claim 1, wherein a battery which powers the processor of the modular camera is housed within an external camera module of the plurality of external camera modules and wherein the modular camera contains no separate battery.

6. The modular camera of claim 1, further comprising a user interface which causes the processor to initiate the capture of digital video and photographic data.

7. The modular camera of claim 1, further comprising a plurality of microphones capable of capturing digital audio data corresponding to the digital video data.

8. The modular camera of claim 1, further comprising a light which provides a notification that a camera event has occurred.

9. The modular camera of claim 1, further comprising a global positioning system (GPS) including a GPS antenna and module which generates location and time information by the GPS antenna communicating with a GPS satellite, wherein the GPS module associates the location and time information with corresponding captured digital video and photograph data.

10. The modular camera of claim 1, wherein the modular camera is configured to couple with a first external module that includes a battery which provides power to the modular camera when coupled with the modular camera, the modular camera containing no independent power source, and configured to couple with a second external module which is configured to electrically connect with an external computing device to enable the transfer of stored captured digital video and photograph data to and from the modular camera, the external computing device serving as an external power source when the modular camera is coupled to the second external module.

11. A modular camera system comprising:
a modular camera core comprising:
a camera capable of capturing digital video, audio, and photograph data;
a processor capable of controlling the controller to initiate the capture of digital video, audio, or photographic data and receive the captured digital video, audio, or photograph data and transferring the captured video, audio, and photograph data to an external computing device;
a memory connected to the processor for storing captured digital video, audio, and photograph data;
an electrical connection connected to the processor; and
a housing which houses the camera, processor, and the electrical connection; and
a plurality of external camera modules each of which is configured to couple with the modular camera core, each of which encloses at least a portion of the housing and which includes a housing electrical connection which connects electrically to the electrical connection of the modular camera core.

12. The modular camera system of claim 11, the modular camera further comprising a means for communicating with an external computing device.

13. The modular camera system of claim 12, wherein the means for communicating with an external computing device comprises a wireless communication system.

14. The modular camera system of claim 13, wherein the wireless communication system enables the external computing device to communicate with the processor to control the processor and remotely initiate the capture of digital video and photograph data.

15. The modular camera system of claim 11, wherein a battery which powers the processor of the modular camera is housed within an external camera module of the plurality of external camera modules and wherein the modular camera core contains no separate battery.

16. The modular camera system of claim 11, wherein the modular camera core further comprises a user interface which causes the processor to initiate the capture of digital video and photographic data.

17. The modular camera system of claim 11, wherein the modular camera core further comprises a plurality of microphones capable of capturing digital audio data corresponding to the digital video data.

18. The modular camera system of claim 11, wherein the modular camera core further comprises a light which provides a notification that a camera event has occurred.

19. The modular camera system of claim 11, wherein the modular camera core further comprises a global positioning system (GPS) including a GPS antenna and module which generates location and time information by the GPS antenna communicating with a GPS satellite, wherein the GPS module associates the location and time information with corresponding captured digital video and photograph data.

20. The modular camera system of claim 11, the plurality of external camera modules comprises a first external module that includes a battery which provides power to the modular camera core when coupled with the modular camera core, the modular camera core containing no independent power source, and a second external module which is configured to electrically connect with an external computing device to enable the transfer of stored captured digital video and photograph data to and from the modular camera core when coupled to the modular camera core, the external computing device serving as an external power source when the modular camera is coupled to the second external module.
